(19) United States
(12) Patent Application Publication
(10) Pub. No.: US 2009/0120750 A1
(43) Pub. Date: May 14, 2009

(54) HYDRAULIC BRAKE LEVER

(75) Inventor: Cheng Wen CHEN, Songgang Town (CN)

Correspondence Address: ERIC CHAN, 42 PIN OAKS DRIVE, PHOENIXVILLE, PA, 19460, US

(73) Assignee: HSIN-TECH (SHEN ZHEN) CO., LTD, Songgang Town (CN)

(21) Appl. No.: 11/937,510

(22) Filed: Nov. 9, 2007

(51) Int. Cl. B60T 13/12

(52) U.S. Cl. 188/344

(57) ABSTRACT

A hydraulic brake lever generally includes a brake lever base, a handle hinged to the brake lever base, an oil reservoir and a half cover. The brake lever base may include a connecting portion and a main portion. A top of the connecting portion may be cooperable with the half cover to mount the hydraulic brake lever to a handlebar. The main portion may include a brake lever cylinder. The brake lever cylinder may include a return spring biasing a piston in the brake lever cylinder. The piston may have an outer end hinged with a push rod and another end hinged with the handle. The oil reservoir may be disposed in one side of the connecting portion adjacent the handle, and fluidly coupled to the brake lever cylinder. The position of the oil reservoir may be higher than the position of the brake lever cylinder.

### BACKGROUND OF THE INVENTION

1. Field of the Invention

The present invention relates to hydraulic brake apparatus, and more particularly, to a hydraulic brake lever.

2. Description of Related Art

Hydraulic brakes have been widely used. For example, Chinese patent ZL 90207299.4 discloses a hydraulic brake apparatus for a bicycle, which includes a n-shaped brake bracket with a brake cylinder and a brake rubber pad mounted thereon. A brake handle base is hinged to a hinge handle. A brake handle cylinder, coupled to one end of the brake cylinder through an oil tube, is disposed in the brake handle base. The other end of the brake cylinder has a press rod. The press rod includes a press rod sleeve hinged to the brake handle. The press rod sleeve is operable to press the press rod to move a piston of the brake handle cylinder, causing the brake cylinder to move the rubber pad, such that the rubber pad is tightly engaged with an end surface of a bicycle rim to brake the bicycle. The brake handle base also includes an oil reservoir fluidly coupled to the brake handle cylinder through an oil conduit so as to supply the oil to the brake handle cylinder when necessary. The oil supply mechanism is that: the oil in the oil reservoir is automatically supplied to the brake handle cylinder by the function of the gravity; when the oil reservoir has an insufficient amount of oil therein, the oil reservoir can be recharged with an exterior oil source. Because of the use of the gravity function, the reservoir is required to be positioned higher than the brake handle cylinder.

In one conventional hydraulic brake, the oil reservoir is usually disposed at one side of the brake handle base. However, due to the left-right symmetry of the brake handle, manufacturing of the brake handle needs two sets of moulds, thus leading to a high manufacturing cost. If the two sides commonly use one set of mould, a problem would be caused that the oil reservoir at one side of the brake handle is located higher than the oil tube and therefore can achieve automatic oil supply, but the oil reservoir at the other side is located lower than the oil tube and therefore cannot achieve automatic oil supply, and a portion of the oil may flow back to the oil reservoir.

In another conventional hydraulic brake, the oil reservoir is disposed at a bottom end of the brake handle base, which can avoid the need of two sets of moulds. However, as the bottom end is connected to a bicycle handle, the oil reservoir faces right toward the bicycle handle. As a result, filling the oil to the oil reservoir can be troublesome.

### SUMMARY OF THE INVENTION

Embodiments of the present invention provides a hydraulic brake level that can reduce the manufacturing cost and facilitate the oil supply to the reservoir.

In one illustrative embodiment, a hydraulic brake lever is discussed. The hydraulic brake lever generally includes a brake lever base, a handle hinged to the brake lever base, an oil reservoir and a half cover. The brake lever base may include a connecting portion and a main portion connected to a bottom end of the connecting portion. A top of the connecting portion may be cooperable with the half cover to mount the hydraulic brake lever to a handlebar. The main portion may include therein a brake lever cylinder. The brake lever cylinder may include therein a return spring biasing a piston in the brake lever cylinder. The piston may have an outer end hinged with a push rod and another end hinged with the handle. The oil reservoir may be disposed in one side of the connecting portion adjacent the handle, and fluidly coupled to the brake lever cylinder. The position of the oil reservoir may be higher than the position of the brake lever cylinder.

In one illustrative embodiment, the main portion may have an internal chamber. One end of the chamber may have an oil outlet fluidly coupled to an oil tube, and the piston may insert into and seal the other end of the chamber to form the brake lever cylinder.

Among others, the illustrated hydraulic brake lever has the following advantages: the position of oil reservoir is always higher than the position of the brake lever cylinder, such that the drawback of the conventional hydraulic brake lever may be overcome. It no longer needs to consider the difference between the left or right side of the brake lever base due to the location of the oil reservoir. Therefore, only one set of mould is needed, thus effectively reducing the manufacturing cost. In addition, the oil reservoir is located in the side of the brake lever base that is adjacent the handle, which facilitates the oil-filling into the oil reservoir.

### BRIEF DESCRIPTION OF THE DRAWINGS

FIG. 1 is a side view of a hydraulic brake lever in accordance with one embodiment.

FIG. 2 is a cross sectional view of the hydraulic brake lever of FIG. 1, taken along line A-A.

### DETAILED DESCRIPTION OF THE PREFERRED EMBODIMENTS

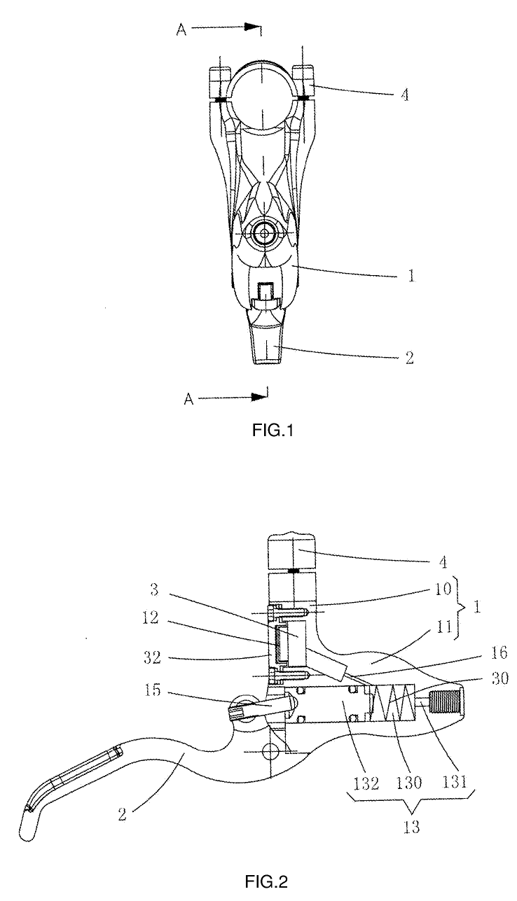

FIGS. 1 and 2 illustrate a hydraulic brake level in accordance with one embodiment. The hydraulic brake level is described in the following in connection with a bicycle. It should be understood that, however, the hydraulic brake lever could be used with various wheeled apparatus other than bicycle. In this illustrative embodiment, the hydraulic brake level generally includes a brake level base 1, a handle 2, an oil reservoir 3 and a half cover 4.

The brake level base 1 has a shape of figure “7” and includes a connecting portion 10 and a main portion 11 located at a bottom end of the connecting portion 10. The connecting portion 10 has a semicircular recessed surface at a top end of the connecting portion 10. The semicircular recessed surface cooperates with the half cover 4 to mount the hydraulic brake level to a bicycle handlebar. A cavity 12 is formed in a side of the connecting portion 10 adjacent the handle 2. The main portion 11 includes therein a brake lever cylinder 13 that is fluidly coupled to a brake cylinder (not shown) at a bicycle wheel through an oil tube (not shown). A push rod 15 is hinged to an end of a piston 132 of the brake lever cylinder 13. A return spring 16 is mounted in the brake lever cylinder 13 such that the return spring 16 moves the piston 132 back when the brake is released. The brake lever cylinder 13 may be constructed as a separate individual assembly that is assembled in the main portion 11. In an alternative embodiment, as shown in FIG. 2, the brake lever cylinder 13 may also be integrally formed with the main portion 11. In the later case, a chamber 130 is formed in an interior of the main portion 11, an oil outlet 131 is formed at one end of the chamber 130 to be fluidly coupled to the oil tube, and the piston 132 inserts into and seals the other end of the chamber 130 to thereby form the brake lever cylinder 13.

On end of the handle 2 is hinged to the brake lever base 1 and the handle 2 is hinged to the push rod 15 to be movable with the push rod 15.

The oil reservoir 3 is disposed in the cavity 12 of the connecting portion 10 of the brake lever base 1. The oil reservoir 3 is in fluid communication with the brake lever cylinder 13 through an oil conduit 30 such that when necessary the oil reservoir 3 can supply oil in the oil reservoir 3 to the brake lever cylinder 13. An oil cover 32 is further disposed outside the oil reservoir 3 to seal the oil reservoir 3. In this illustrative embodiment, the oil cover 32 is mounted to the oil reservoir using screws. In one embodiment, the oil cover 32 needs to be open before the oil is supplied into the oil reservoir 3.

During braking action, when the handle 2 is rotated by a driver to move the push rod 15 and in turn cause the piston 132 to move linearly, the oil is caused to flow from the brake lever cylinder 13 through the oil tube to the brake cylinder, and the resultant oil pressure drives a corresponding brake pad to brake the bicycle. As the driver releases the handle, the piston 132 can be returned to its original position under the force of the return spring 16.

After the brake lever is mounted to the bicycle handlebar, the position of the connecting portion 10 is higher than the position of the main portion 11, and the position of the oil reservoir 3 in the connecting portion 10 is also higher than the position of the brake lever cylinder 13 in the main portion 11. Therefore, the oil in the oil reservoir 3 can be automatically supplied to the oil conduit 30 and the brake lever cylinder 13 coupled to a bottom end of the oil conduit 30 by the function of the gravity. When the oil reservoir 3 has an insufficient amount of oil, the oil cover 32 may be opened to recharge the oil reservoir 3 from an exterior oil source.

In the hydraulic brake lever described above, the oil reservoir is positioned at a location such that the drawback of the conventional hydraulic brake lever may be overcome. It no longer needs to consider the difference between the left or right side of the brake lever base due to the location of the oil reservoir 3. Therefore, only one set of mould is needed, thus effectively reducing the manufacturing cost. In addition, the oil reservoir 3 is located in the side of the brake lever base 1 that is adjacent the handle 2, which facilitates the oil-filling into the oil reservoir 3.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

I claim:

1. A hydraulic brake lever, comprising a brake lever base, a handle hinged to the brake lever base, an oil reservoir and a half cover, the brake lever base comprising a connecting portion and a main portion connected to a bottom end of the connecting portion, a top of the connecting portion being cooperable with the half cover to mount the hydraulic brake lever to a handlebar, the main portion comprising therein a brake lever cylinder, the brake lever cylinder having therein a return spring biasing a piston in the brake lever cylinder, the piston having an outer end hinged with a push rod and another end hinged with the handle, wherein the oil reservoir is disposed in one side of the connecting portion adjacent the handle and is fluidly coupled to the brake lever cylinder, and the position of the oil reservoir is higher than the position of the brake lever cylinder.

2. The hydraulic brake lever in accordance with claim 1, wherein the main portion has an internal chamber, one end of the chamber has an oil outlet fluidly coupled to an oil tube, and the piston inserts into and seals the other end of the chamber to form the brake lever cylinder.

3. The hydraulic brake lever in accordance with claim 1, wherein a cavity is formed in the side of the connecting portion that is adjacent the handle, the oil reservoir is disposed in the cavity, and the cavity is sealed by an oil cover.

4. The hydraulic brake lever in accordance with claim 2, wherein a cavity is formed in the side of the connecting portion that is adjacent the handle, the oil reservoir is disposed in the cavity, and the cavity is sealed by an oil cover.

5. The hydraulic brake lever in accordance with claim 1, wherein the half cover is fastened to the top of the connecting portion using a screw, and a top surface of the connecting portion and an inner surface of the half cover form respectively recessed surfaces that are fastened together to define a hole allowing a handlebar to extend therethrough.
